(19) United States
(12) Patent Application Publication
(10) Pub. No.: US 2004/0161039 A1
(43) Pub. Date: Aug. 19, 2004

(54) Methods, systems and computer program products for encoding video data including conversion from a first to a second format

(76) Inventors: Patrik Grundstrom, Malmo (SE); Per Thorell, Lund (SE); Ted Hansson, Helsingborg (SE)

Correspondence Address: MYERS BIGEL SIBLEY & SAJOVEC, PO BOX 37428, RALEIGH, NC, 27627, US

(21) Appl. No.: 10/716,949

(22) Filed: Nov. 19, 2003

Related U.S. Application Data
(60) Provisional application No. 60/447,902, filed on Feb. 14, 2003.

(51) Int. Cl. H04N 7/12

(52) U.S. Cl. 375/240.24; 375/240.01

(57) ABSTRACT

Video data can be received in a first format. The video data comprises a plurality of video frames, with each frame comprising a plurality of blocks. A block of a current one of the video frames can be converted to a second format. The block of the current video frame can be compared to a corresponding block of another video frame. The block of the current video frame can be encoded responsive to comparing the block of the current video frame to the corresponding block of the other frame.

### RELATED APPLICATIONS

This application claims priority to U.S. Provisional Application No. 60/447,902, filed Feb. 14, 2003, the disclosure of which is hereby incorporated herein by reference in its entirety as if set forth fully herein.

### FIELD OF THE INVENTION

This invention relates to video data, and more particularly to encoding video data.

### BACKGROUND OF THE INVENTION

The encoding/decoding, processing and transmission of video data may require relatively large memory resources. Video data from a video camera can be compressed and encoded into a format that requires less memory for storage or transmission. In some systems, however, the memory needed to process a single video frame may exceed the available memory in the processor. For example, telecommunications devices such as radiophones and other small, hand held communications devices can include video camera equipment for recording video. However, these and other video devices may have limited memory resources for processing the video data.

### SUMMARY OF THE INVENTION

Embodiments of the present invention may provide methods, systems and/or computer program products for processing video data. Video data can be received in a first format. The video data may comprise a plurality of video frames, with each frame comprising a plurality of blocks. A block of a current one of the video frames can be converted to a second format. The block of the current video frame can be compared to a corresponding block of another video frame. The block of the current video frame can be encoded responsive to comparing the block of the current video frame to the corresponding block of the other frame.

In further embodiments of the present invention, converting the block of the current video frame can be performed prior to receiving an entirety of the current video frame. Each block of a video frame can include a predefined grouping of pixels. In some embodiments, the second format may have a lower resolution than the first format. For example, the second format may have reduced chrominance information as compared to the first format. The second format can include interleaved chrominance and luminance data.

In some embodiments, encoding the block of the current video frame may include compressing the block of the current video frame. Comparing the block of the current video frame to a corresponding block of another video frame can be preceded by retrieving the corresponding block of the other video frame in the second format. The block of the current video frame can be stored in the second format for comparison with a corresponding block of a subsequent video frame.

In further embodiments, the encoded video data for a portion of the block can be stored in a buffer, and the buffered data can be transferred to a memory location on completion of encoding the block. A portion of the block of video data can be transferred from the buffer to the memory location if the buffer is full prior to encoding the entire block of video data. In still further embodiments, the encoded block of the current video frame can be transmitted over a wireless communications link.

As will be appreciated by those of skill in the art in light of the present disclosure, the present invention may be embodied as methods, systems, and/or computer program products.

### BRIEF DESCRIPTION OF THE DRAWINGS

FIG. 1 is a block diagram of communications systems according to some embodiments of the present invention.

FIG. 2 is a block diagram of mobile terminals and/or base stations according to some embodiments of the present invention.

FIG. 3 is a block diagram of processors and memories according to embodiments of the present invention.

FIG. 4 is a block diagram of systems according to embodiments of the present invention.

FIGS. 5-7 are flowcharts illustrating operations according to embodiments of the present invention.

FIG. 8 is a diagram of non-interleaved YCbCr 4:2:0 format video data according to embodiments of the present invention.

FIG. 9 is a diagram of interleaved YCbCr 4:2:0 format video data according to embodiments of the present invention.

FIG. 10 is a diagram of interleaved YCbCr 4:2:2 format video data according to embodiments of the present invention.

### DETAILED DESCRIPTION OF EMBODIMENTS

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout.

The present invention is described below with reference to block diagrams and/or flowchart illustrations of methods and mobile terminals according to embodiments of the invention. It is understood that each block of the block diagrams and/or flowchart illustrations, and combinations of blocks in the block diagrams and/or flowchart illustrations, can be implemented by radio frequency, analog and/or digital hardware, and/or computer program instructions. These computer program instructions may be provided to a processor of a general purpose computer, special purpose computer, digital signal processor, and/or other programmable data processing apparatus, for example, in a mobile terminal or base station, such that the instructions, which execute via the processor of the computer and/or other programmable data processing apparatus, create a circuit and/or means for implementing the functions/acts specified in the block diagrams and/or flowchart block or blocks.

These computer program instructions may also be stored in a computer-readable memory that can direct a mobile terminal to function in a particular manner, such that the instructions stored in the computer-readable memory produce an article of manufacture including instructions which implement the functions/acts specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks. It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

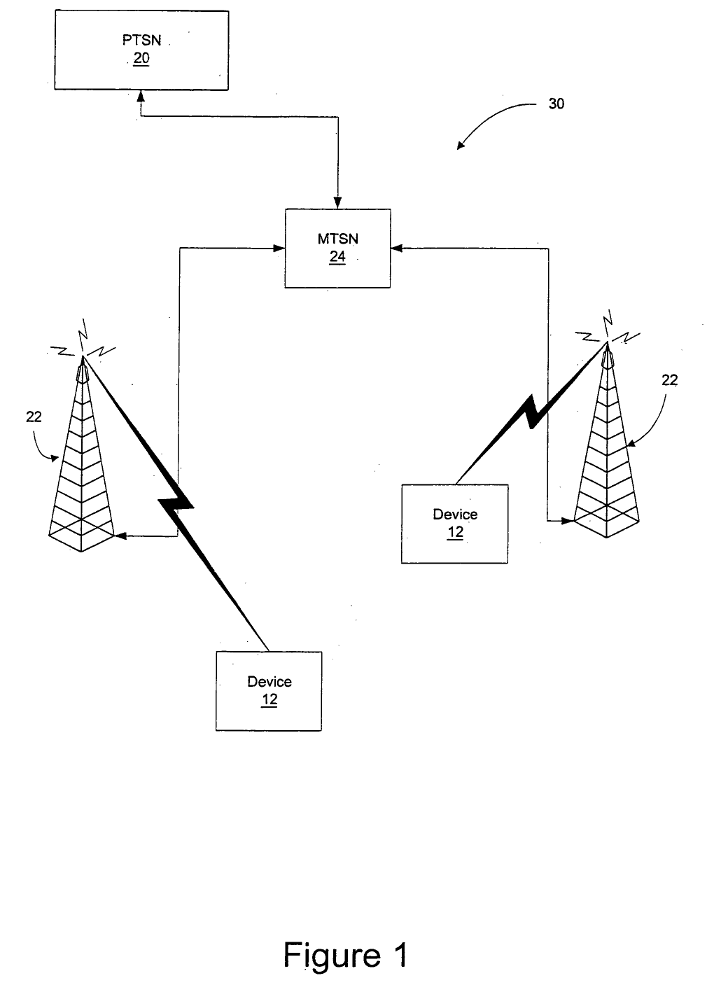

Various embodiments of the present invention will now be described with reference to the figures. FIG. 1 illustrates an exemplary embodiment of a communications system 30 suitable for transmitting and encoding video data in accordance with embodiments of the present invention. The communications system 30 may include communications devices 12 such as radiotelephones or other mobile hand-held devices that communicate through one or more mobile telecommunications switching offices (MTSO) 24 via base stations 22. The MTSO 24 may provide communications with a public telecommunications switching network (PTSN) 20.

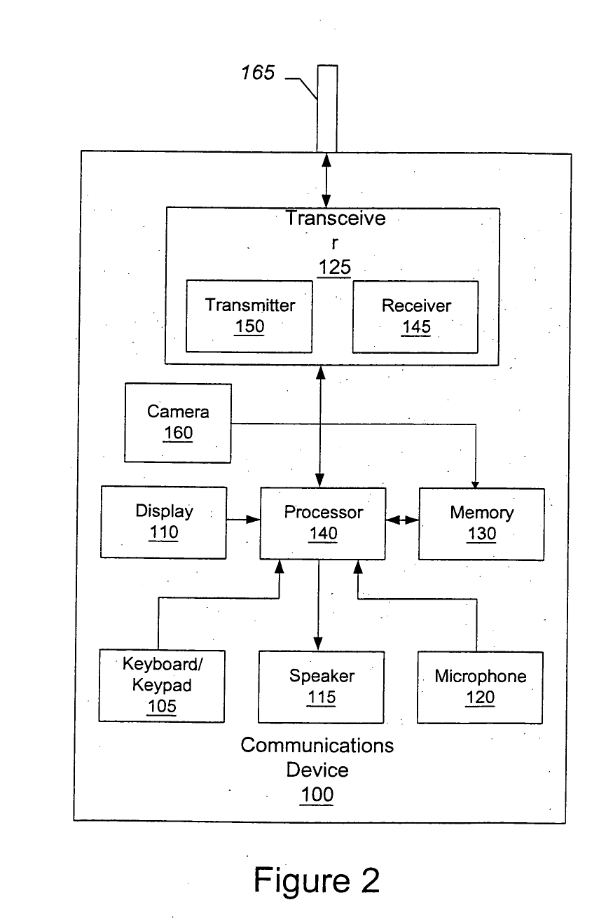

A schematic block diagram illustration of a communications device 100, such as a mobile terminal is shown in FIG. 2. The device 100 may include a transceiver 125, and a memory 130 that communicates with a processor 140. As is also illustrated in FIG. 2, the communications device 100 may also include one or more of a keyboard/keypad 105, a display 110, a speaker 115 and/or a microphone 120. The device 100 may also include a camera 160 that transmits video data to the processor 140 and/or memory 130. The camera 160 can be provided as part of the device 100 or the camera 160 can be a separate device coupled to the device 100.

The device 100 may carry out operations described herein for processing video data. For example, in some embodiments, the processor 140 can process video data from the memory 130 to convert data from a first format to a second format. The memory 130 can include video data in the first format. The processor 140 can also compress the video data. For example, the video data may include a plurality of video frames, with each frame including a plurality of blocks of video data. The processor 140 can receive the video data in the first format from the memory 130. The processor 140 can convert a block of video data in a current video frame to the second format. The processor 140 can then compare the block of the current video frame to a corresponding block of another video frame. The processor 140 can encode the block of the current video frame responsive to comparing the block of the current video frame to the corresponding block of the other video frame. The other video frame can be a previous video frame.

Accordingly, the processor 140 can process the video data in blocks, with each block being small enough to be processed by the memory in the processor 140. In some embodiments, all or some of the video data can be stored in memory 130 and accessed by the processor 140 through Direct Memory Access (DMA) over a common bus. The video data can be stored in external memory or it can be stored in internal memory on the same device as the processor. A DMA controller may handle the data flow so that the needed data may be sent to and from the processor at fixed intervals.

Video frames are referred to herein as “current” video frames, “previous” video frames, and “subsequent” video frames. It is to be understood that “current”, “previous”, and “subsequent” refer to the relationship of the frames as the frames are encoded and does necessarily not refer to real time information or the absolute sequence of frames as stored in memory. Although the previous frame may be one frame prior to the current frame in a sequence of frames of video data, the video data can be processed in any suitable order. For example, the “previous” video frame could be one frame prior to the current frame in the time sequence in which the frames are recorded by a video camera or multiple frames prior.

Referring to FIG. 2, the transceiver 125 may include a transmitter 150 and a receiver 145, which respectively transmit outgoing radio frequency signals to a base station or wireless terminal and receive incoming radio frequency signals to the base station or wireless terminal via an antenna 165. In some embodiments, radio frequency signals can be used to transmit encoded video data. While a single antenna 165 is shown in FIG. 2, it is to be understood that multiple antennas and/or different types of antennas may be utilized based on the types of signals being received. The radio frequency signals transmitted between the communications device 100 and a base station/mobile terminal may comprise both traffic and control signals (e.g., paging signals/messages for incoming calls), which are used to establish and maintain communication with another party or destination, and may provide uplink and/or downlink communications, including transmission of video data. However, the present invention is not limited to such two-way communication systems or network environments.

Some components of the communications devices discussed herein may be included in conventional mobile terminals and certain aspects of their functionality is generally known to those skilled in the art. It should be further understood, that, as used herein, the term “mobile terminal” may include, but is not limited to, a cellular radiotelephone with or without a multi-line display; a Personal Communications System (PCS) terminal that may combine a cellular radiotelephone with data processing, facsimile and data communications capabilities; a Personal Data Assistant (PDA) that can include a radiotelephone, pager, Internet/intranet access, Web browser, organizer, calendar and/or a global positioning system (GPS) receiver; and/or a conventional laptop and/or palmtop receiver or other appliance that includes a radiotelephone transceiver. Mobile terminals may also be referred to as “pervasive computing” devices.

Although the present invention may be embodied in communication devices or systems, such as the communications device 100, the present invention is not limited to such devices and/or systems. Instead, the present invention may also be embodied in any method, transmitter, communication device, communication system, or computer program product that utilizes encoded video data, including stand-alone devices.

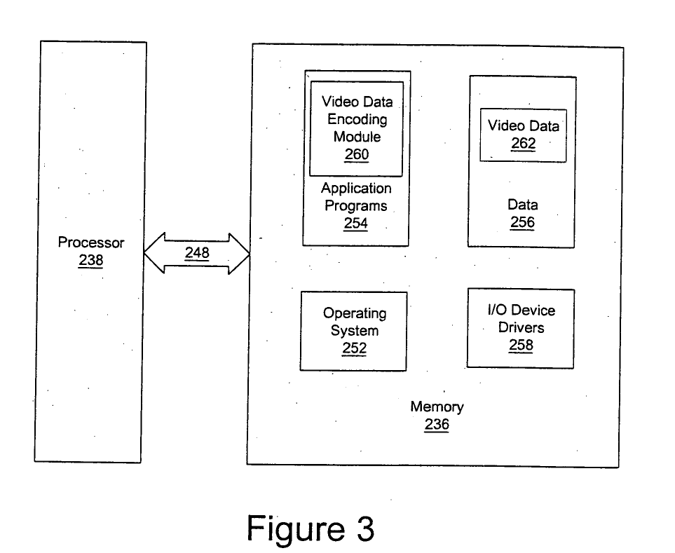

FIG. 3 is a block diagram of embodiments according to the present invention that illustrates systems, methods, and computer program products. Embodiments illustrated in FIG. 3 may be implemented in a communications device or a stand-alone device. The processor module 238 communicates with the memory 236 via an address/data bus 248. The processor module 238 can include any commercially available or custom microprocessor including, for example, a digital signal processor. The processor module 238 can also contain a limited amount of memory. The memory may be used for storage of frequently used program code or data, and/or it may be used as a temporary storage for video images or portions of video images. The memory 236 is representative of the overall hierarchy of memory devices containing the software and data used to implement the functionality of the device 200. The memory 236 can include one or more of, but is not limited to, the following types of devices: cache, ROM, PROM, EPROM, EEPROM, flash memory, SRAM, and DRAM.

As shown in FIG. 3, the memory 236 may include several categories of software and/or data used: an operating system 252; application programs 254; input/output (I/O) device drivers 258; and data 256. As will be appreciated by those of skill in the art, the operating system 252 may be any operating system suitable for use with a mobile terminal, such as VxWorks or pSOSystem from Wind River Alameda, Calif., OSE Delta, OSEck or OSE Epsilon from Enea Data, Stockholm Sweden, WindowsCE, Windows95, Windows98, Windows2000, WindowsNT or WindowsXP from Microsoft Corporation, Redmond, Wash., Unix, Linux, Palm OS, custom and/or proprietary operating systems. The operating systems may be configured to support an IP-based or other such network communication protocol connection. The I/O device drivers 258 may include software routines accessed through the operating system 252 by the application programs 254 to communicate with devices such as transceiver 125 (FIG. 2) and certain components of the memory 236. The application programs 254 are illustrative of the programs that implement the various features and may include at least one application that supports operations according to embodiments of the present invention. The data 256 represents the static and/or dynamic data used by the application programs 254, the operating system 252, the I/O device drivers 258, and other software programs that may reside in the memory 236.

As is further seen in FIG. 3, the application programs 254 may include a video data encoding module 260. The video data encoding module 260 may carry out operations described herein for processing video data. The data portion 256 of the memory 236, as shown in the embodiments of FIG. 3, may include video data 262 that stores video information as described herein. In some embodiments, the video data encoding module 260 may be a part of the internal memory of the processor module 238.

For example, video data 262 can be sent from the memory 236 and received by the video data encoding module 260. The video data encoding module 260 can receive the video data in a first format, and the video data can include a plurality of video frames, with each frame including a plurality of blocks. The video data encoding module 260 can convert a block of a current one of the video frames to a second format and can compare the block of the current video frame to a corresponding block of another video frame. The video data encoding module 260 can encode the block of the current video frame responsive to comparing the block of the current video frame to the corresponding block of the other frame. The other frame can be a previous video frame.

While the present invention is illustrated, for example, with reference to the video data encoding module 260 being an application program in FIG. 2, as will be appreciated by those of skill in the art, other configurations may also be utilized while still benefiting from the teachings of the present invention. For example, the video data encoding module 260 may also be incorporated into the processor module 238, operating system 252, the I/O device drivers 258 or other such logical division. Thus, the present invention should not be construed as limited to the configuration of FIG. 3 but is intended to encompass any configuration capable of carrying out the operations described herein. Moreover, an integrated circuit including the processor module 238 may also include memory elements of memory 236, and/or an integrated circuit(s) including memory 236 may perform functionality of processor module 238.

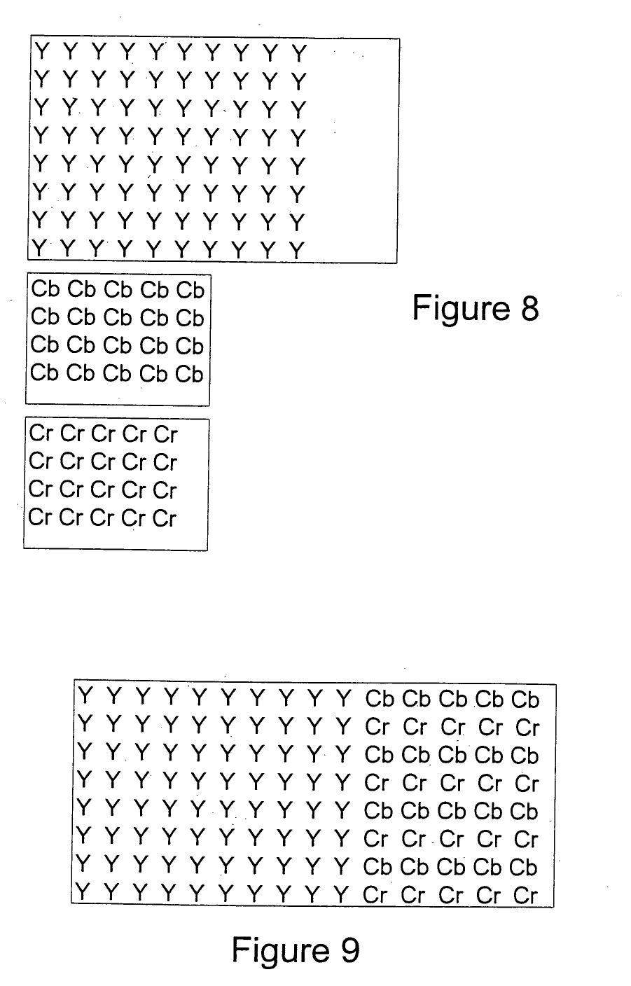

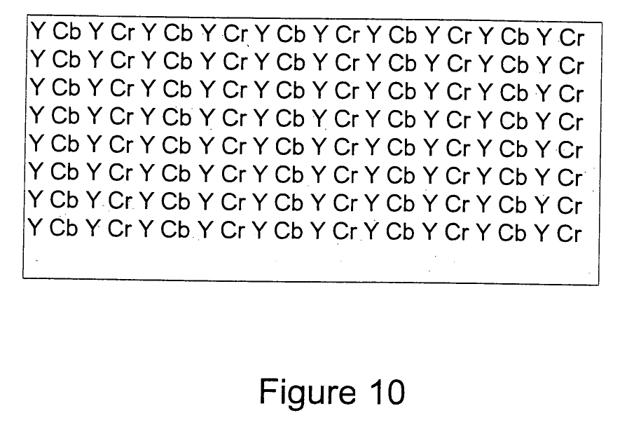

The video data encoding module 260 may include an algorithm for encoding video data according to MPEG-1, MPEG-2, MPEG-4, H.261, H.263, N.264, and/or any other proprietary or custom video encoding specification. The video data encoding module 260 may also include an algorithm for decoding video data. Video encoders, such as the MPEG-4 and H.263 standards, may operate in a YCbCr 4:2:0 format. In this format, the luminance component (Y) is stored in full resolution and the chrominance components (Cb (chrominance blue) and Cr (chrominance red)) are sub-sampled by a factor of two in both the horizontal and vertical directions. As shown in FIG. 8, the YCbCr 4:2:0 format may be stored as one continuous memory block for all luminance pixels and two separate memory blocks for the two chrominance components, Cb and Cr. However, an interleaved YCbCr 4:2:0 format, in which the chrominance and luminance data is stored in one continuous memory block, may alternatively be used. An example of an interleaved YCbCr 4:2:0 format is shown in FIG. 9. In contrast, video cameras may deliver video data in byte interleaved YCbCr 4:2:2 format, as shown in FIG. 10. The YCbCr 4:2:2 format has twice the amount of chrominance data compared to YCbCr 4:2:0 format, because the chrominance components Cb and Cr are not sub-sampled in the vertical direction.

As shown in FIG. 3, the data 256 can include video data 262 comprising a plurality of video frames, with each frame comprising a plurality of blocks of data. A “block” of data is a predefined grouping of pixels. One specific example of a block of video data is a macroblock. For example, each frame can include 176 columns and 144 rows of pixels (176×144 pixels). A block of data can be 8×8 pixels, and a macroblock can contain four 8×8 blocks of luminance data, and can furthermore contain one or more 8×8 block(s) of chrominance blue (Cb) and one or more 8×8 blocks of chrominance red (Cr). A number of macroblocks can be grouped into a “macroblock line”. A frame size of 176×144 may, for example, be divided into nine macroblock lines, each containing one row of macroblocks. However, various sizes of frames and/or blocks can be used. As used herein, a “block” of video data can be a block, a macroblock, a macroblock line, or any suitable grouping of pixels.

In YCbCr 4:2:2 format, one macroblock of data can include 4 luminance components (Y), 2 chrominance red components (Cr), and 2 chrominance blue components(Cb). In YCbCr 4:4:0 format, one macroblock of video data can include 4 luminance components (Y), 1 chrominance red component (Cr) and 1 chrominance blue component (Cb).

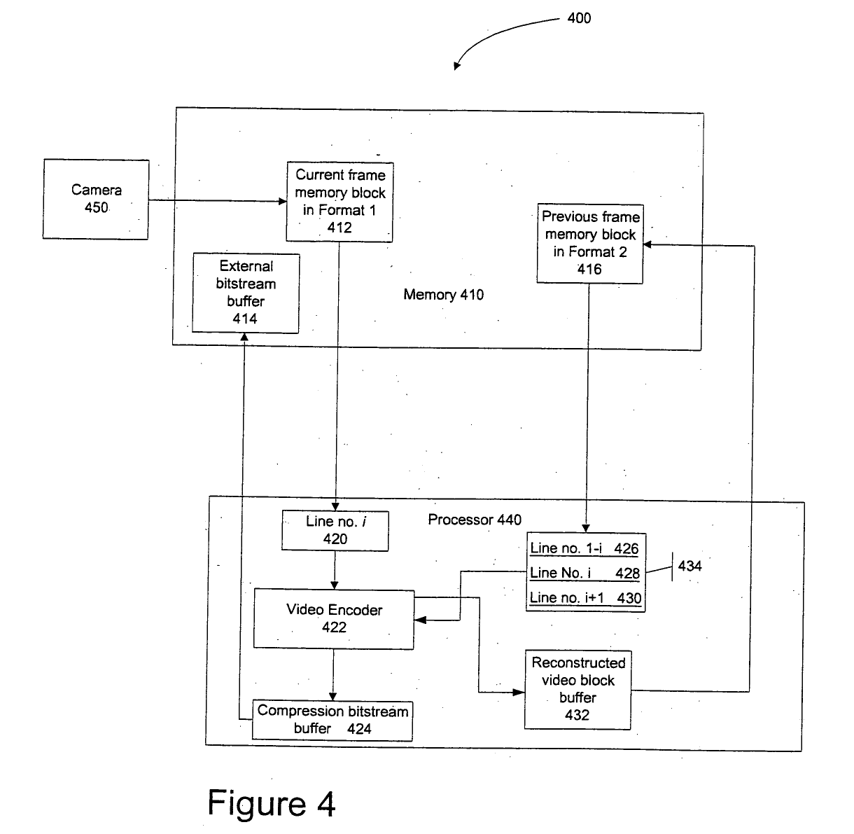

FIG. 4 is a block diagram of a video processing system 400 according to certain embodiments of the present invention. In overview, and as seen in FIG. 4, a digital camera 450 transmits video data in a first format to a memory block 412 in memory 410. The memory 410 communicates with the processor 440, which encodes the video data to produce reconstructed video data in a second format using a video encoder 422. The reconstructed video data is transmitted to a memory block 416 in the memory 410. The video encoder 422 uses reconstructed video data from other video frames to encode and compress the converted video data.

More specifically, the camera 450 transmits a single block of data from a current frame (i.e., macroblock Line no. i) in a first format from memory block 412 to the input buffer 420 of the processor 440. In some embodiments, the first format can be YCbCr 4:2:2 format. A corresponding block of reconstructed video data in a second format is sent from memory block 416 to the input buffer 434. The reconstructed video data in the input buffer 434 can be reconstructed data from a previous frame (previous macroblock Line no. i (Block 428)) and can include adjacent blocks from the same previous frame (previous macroblock Line no. 1−i (Block 426); previous macroblock Line no i+1 (Block 430)). In some embodiments, the reconstructed video data in the input buffer 434 can be stored in a third format. In some embodiments, edge pixels of video data can be padded to the frame according to techniques known to those of skill in the art. “Padding” may be provided by extrapolating data within an area to pixels outside the area, and can be used to provide better motion prediction.

A video encoder 422 converts the macroblock of data from the input buffer 420 to a second format. In some embodiments, a separate video encoder may be provided to convert the macroblock of data from the input buffer 240 to the second format. The second format can be an interleaved YCbCr 4:2:0 format, such as the interleaved YCbCr 4:2:0 format shown in FIG. 9. An interleaved format may facilitate the processing of video data in blocks because the chrominance and luminance data is interleaved within memory 410, rather than being stored in separate memory blocks, such as in non-interleaved YCbCr 4:2:0 format as shown in FIG. 8. Accordingly, fewer memory read operations may be needed to transfer the interleaved data between the memory 410 and the processor 440 than may be required when the chrominance and luminance data is not interleaved. However, any suitable format of video data can be used for the first and second formats, including non-interleaved and interleaved formats.

In some embodiments, the second format may have a lower resolution than the first format. For example, the second format can have reduced chrominance information as compared to the first format. The reconstructed block of video data from the current frame in the second format is transferred from a reconstructed video block buffer 432 to the previous frame memory block 416 to be used in encoding the next video frame.

The video encoder 422 encodes the converted video data. The video encoder 422 uses the video block from the current frame and the reconstructed block for the previous frames in the input buffer 434. Encoding the block of data from the current frame can include comparing the block of the current video frame to the corresponding video frame and encoding the block of the current video frame responsive to the comparison. In some embodiments, only the differences between the block from the previous frame and the block from the current frame may be encoded to compress the video data. Examples of encoding techniques may be found, for example, in co-pending, U.S. patent application Publication No. 2003/0152149, entitled Method and Device for Block-Based Conditional Motion Compensation, filed Sep. 19, 2002 and published on Aug. 14, 2003, the disclosure of which is hereby incorporated by reference in its entirety.

A compressed bitstream of a portion of the encoded video data can be stored at buffer 424 and transferred to an external bitstream buffer 424 of memory 410. In some embodiments, converting the block of the current video frame from the first format to the second format can be performed prior to receiving an entirety of the current video frame in the first format. Accordingly, the video data can be continuously converted, and the memory used by the compressed bitstream can be reduced.

Moreover, the block of video data can be transferred to the external bitstream buffer 414 from the compression bitstream buffer 424 upon completion of encoding the block of data to “flush” the bitstream buffer. The flushing of the bitstream buffer can reduce the memory needed in the processor 440. In some embodiments, if the compression bitstream buffer 424 is full prior to encoding an entire block of data, the encoded portion of the block of video data can be transferred from the buffer 424 to a memory location, such as the external bitstream buffer 414 prior to encoding the entire block of video data. The transfer of data prior to encoding the entire block of data may occur more often during the encoding of “intra frames”, e.g., frames that are not predicted or unrelated to the previous frame. Intra frames may generate a large amount of encoded video data. In order to maintain an average frame rate, the next frame may be skipped after an intra frame by a rate control mechanism.

While the present invention is illustrated, for example, with reference to the video encoder 422 being part of the processor 440, and various memory blocks in the memory 410, as will be appreciated by those of skill in the art, other configurations may also be utilized while still benefiting from the teachings of the present invention. For example, the memory 410 can be incorporated into the processor 440 and/or other logical division of the memory 410 and processor 440 can be made. A separate video converter (not shown) can be provided to convert the video to different formats. Thus, the present invention should not be construed as limited to the configuration of FIG. 4 but is intended to encompass any configuration capable of carrying out the operations described herein. An integrated circuit including the processor 440 may also include memory elements of memory 410 and/or an integrated circuit(s) including memory 410 may perform functionality of processor 440.

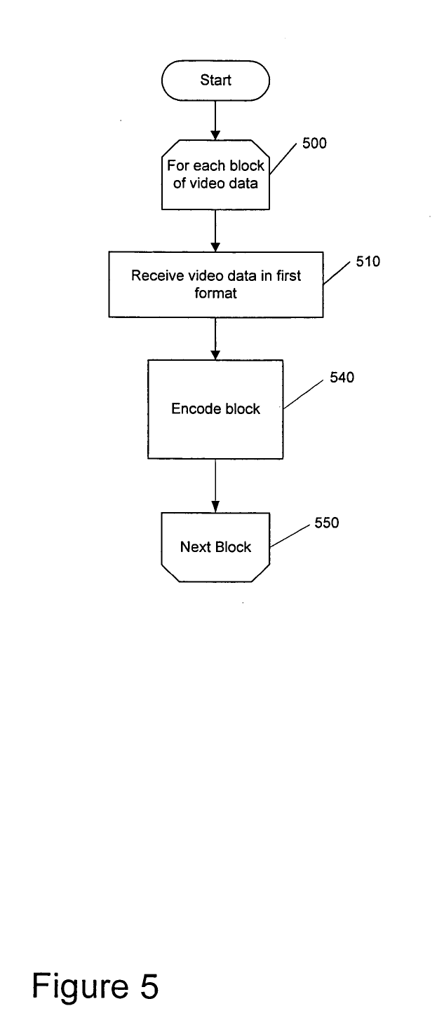

Operations according to embodiments of the present invention will now be described with reference to FIGS. 5 to 7. Referring to FIG. 5, for each block of video data from the current frame at operations Block 500, the video data is received by an encoder at operations Block 510 in a first format. The encoder encodes the block at operations Block 540. The encoder can encode the block by converting a block of video data to a second format. The block of video data in the second format may be compared to a corresponding block of video data (also in the second format) from a previous frame. The block of video data may be encoded based on the comparison between the block of video data and a corresponding block of video data of a previous frame. The encoder then performs the same steps for the next block of video data at operations Block 550.

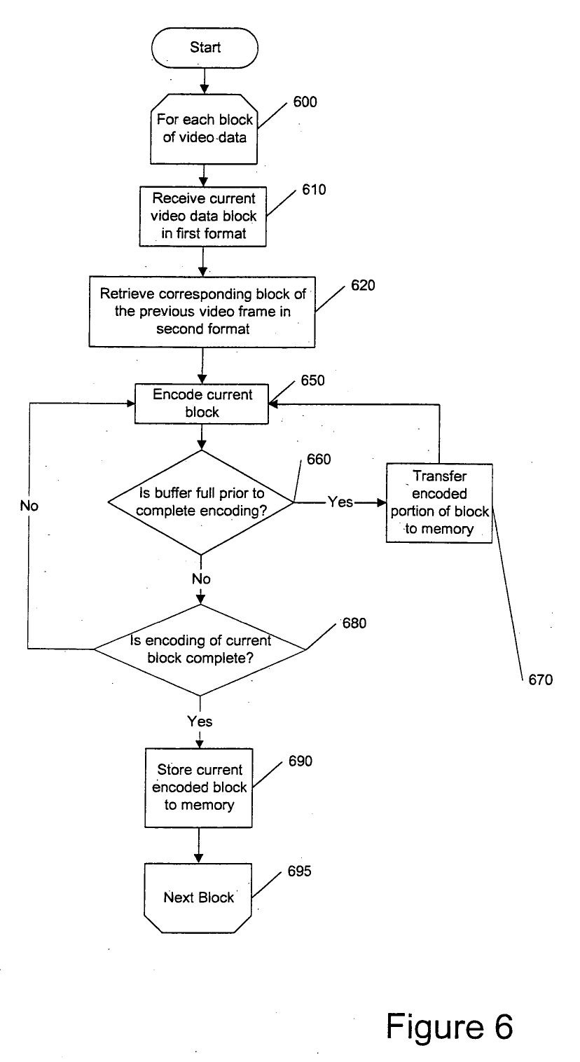

More detailed operations according to embodiments of the present invention are shown in FIG. 6. For each block of video data at operations Block 600, the current video data block is received in a first format at operations Block 610. A corresponding block of the previous video frame in a second format is retrieved at operations Block 620. The current block of video data is encoded at operations Block 650. For example, the current block of video data can be converted to the second format. The second format can have reduced resolution, such as reduced chrominance information, as compared to the first format. For example, the first format can be a YCrCb 4:2:2 format and the second format can be an interleaved YCrCb 4:2:0 format as discussed above.

The current block of video data in the second format can be compared to the corresponding block of a previous frame (in the second format). As described above, video data that is adjacent to the block of video data in the previous frame can be used in the encoding step at operations Block 650, including padding data, e.g., data that is extrapolated from data within an area to pixels outside the area.

Based on the comparison of the current block to the corresponding block of a previous frame, the block of data from the current frame is encoded at operations Block 650 and transferred to a buffer. If the buffer is full prior to complete encoding at operations Block 660, then the encoded portion of the block is transferred to another memory location at operations Block 670. If the encoding of the current block is not complete at operations Block 680, the encoder continues to encode the current block at operations Block 650. If the encoding of the block of the current frame is complete, the encoded block is stored to another memory block at operations Block 690. The encoder can repeat the operations described above for the next block of video data at operations Block 695. Accordingly, a plurality of video data blocks for a plurality of frames of video data can be processed in relatively small portions, and the memory needed to encode the video data can be reduced.

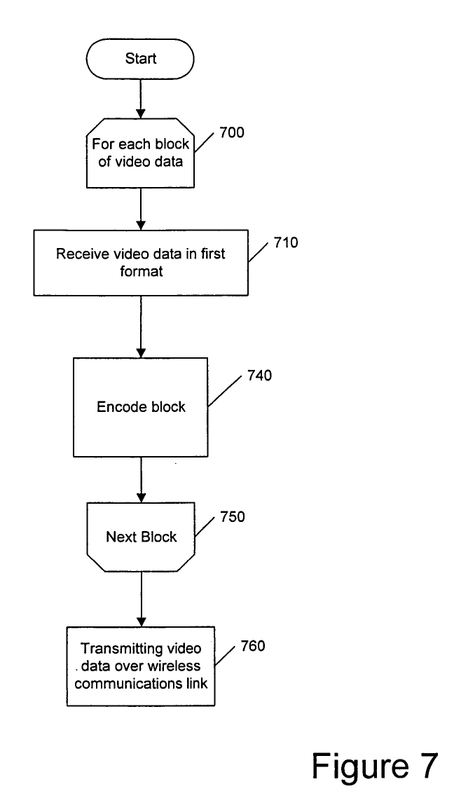

Operations for transmitting encoded video data over a wireless communications link are shown in FIG. 7. For each block of video data from the current frame at operations Block 700, the video data is received by an encoder at operations Block 710. The encoder encodes the block of video data at operations Block 740. For example, the encoder can convert the block of video data to a second format. The block may be compared to a corresponding block from a previous frame. The block can be encoded at operations Block 740 based on the comparison between the block of video data of the current frame and a corresponding block of video data of a previous frame. The above operations can be repeated for a plurality of blocks of video data in a plurality of video frames at operations Block 750. Once the video data has been encoded and/or compressed, the video data can be transmitted over a wireless communications link at operations Block 760.

According to embodiments of the present invention, methods, systems and/or computer program products for processing video data can be provided. Video data can be received in a first format. The video data may comprise a plurality of video frames, with each frame comprising a plurality of blocks. A block of a current one of the video frames can be converted to a second format. The block of the current video frame can be compared to a corresponding block of another video frame. The block of the current video frame can be encoded responsive to comparing the block of the current video frame to the corresponding block of the other frame.

While the present invention has been described with reference to a wireless communications media device, embodiments of the present invention may also be utilized in wired communications media or in a stand-alone video device. Moreover, instead of transmitting the video data, the encoded and/or compressed video data can be stored for later viewing. In some embodiments, stored video data can be encoded and/or compressed.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A method for processing video data, the method comprising:
receiving a block of current video data in a first format;
encoding the block of current video data using data stored in a second format;
storing new data in the second format; and
storing the encoded video data.

2. The method of claim 1, wherein the stored data contains information about a previous frame.

3. The method of claim 1, wherein the stored data contains image data from a previous frame.

4. The method of claim 1, wherein the block of current video data in the first format is a portion of a current frame.

5. The method of claim 1, wherein the stored data in the second format is a portion of a previously coded frame.

6. The method of claim 1, wherein the second format has a lower resolution than the first format.

7. The method of claim 6, wherein the second format comprises reduced chrominance information as compared to the first format.

8. The method of claim 5, wherein the second format comprises interleaved chrominance and luminance data.

9. The method of claim 4, wherein the first format comprises interleaved chrominance and luminance data.

10. The method of claim 4, wherein the first format and the second format comprises interleaved chrominance and luminance data.

11. The method of claim 1, wherein each block of a video frame comprises a predefined grouping of pixels.

12. The method of claim 1, wherein encoding the block of the current video frame comprises compressing the block of the current video frame.

13. The method of claim 1, wherein encoding the block of the current video frame comprises comparing the block of the current video frame to a corresponding block of another video frame.

14. The method of claim 13, wherein comparing the block of the current video frame to a corresponding block of another video frame is preceded by:
retrieving the corresponding block of the other video frame in the second format.

15. The method of claim 1, further comprising:
transferring the new data in the second format to a memory location; and
storing the new data for encoding of a corresponding block of a subsequent video frame.

16. The method of claim 15, further comprising:
storing the encoded video data in a third format in a buffer; and
transferring the buffered data to a memory location on completion of encoding the block.

17. The method of claim 16, further comprising:
transferring a portion of the block of video data from the buffer to the memory location if the buffer is full prior to encoding the entire block of video data.

18. The method of claim 1, further comprising:
transmitting the encoded block of the current video frame over a wireless communications link.

19. The method of claim 1, wherein encoding the block of current video data using the data stored in the second format is preceded by converting a block of a data in the first format to the second format.

20. The method of claim 1, wherein the block of current video data comprises a microblock line of video data.

21. A communications device comprising:
a controller that is configured to receive a block of current video data in a first format, to encode the block of current video data using data stored in a second format, to store new data in the second format, and to store the encoded video; and
a transmitter that is configured to transmit the encoded video data.

22. The communications device of claim 21, wherein the second format has a lower resolution than the first format.

23. The communications device of claim 22, wherein the second format comprises interleaved chrominance and luminance data.

24. The communications device of claim 21, wherein the controller encodes the block of the current video frame by compressing the block of the current video frame.

25. The communications device of claim 21 further comprising:
a buffer that receives the video data; and
a memory location for storing encoded video data;
wherein the controller is further configured to transfer the new data in the second format from the buffer to the memory location, and to encode a corresponding block of a subsequent video frame using new data in the second format from the memory location.

26. The communications device of claim 25, wherein the controller is further configured to transfer a portion of the block of video data from the buffer to the memory location if the buffer is full prior to encoding the entire block of video data.

27. A computer program product for processing video data, comprising:
a computer readable media having computer readable program code embodied therein, the computer readable program code comprising:
computer readable program code configured to receive a block of current video data in a first format;
computer readable program code configured to encode the block of current video data using data stored in a second format;
computer readable program code configured to store new data in the second format; and
computer readable program code configured to store the encoded video data.

28. The computer program product of claim 27, wherein the second format has a lower resolution than the first format.

29. The computer program product of claim 28, wherein the second format comprises interleaved chrominance and luminance data.

30. The computer program product of claim 27, wherein the computer readable program code to encode the block of the current video frame further comprises computer readable program code to compress the block of the current video frame.

31. The computer program product of claim 27 further comprising:
computer readable program code configured to transfer the new data in the second format from a buffer to a memory location;
computer readable program code configure to encode a corresponding block of a subsequent video frame using the new data in the second format in the memory location.

32. The computer program product of claim 31, further comprising computer readable program code configured to transfer a portion of the block of video data from the buffer to the memory location if the buffer is full prior to encoding the entire block of video data.

33. A system for processing video data, the system comprising:
means for receiving a block of current video data in a first format;
means for encoding the block of current video data using data stored in a second format;
means for storing new data in the second format; and
means for storing the encoded video data.

34. The system of claim 33, wherein the second format has a lower resolution than the first format.

35. The system of claim 34, wherein the second format comprises interleaved chrominance and luminance data.

36. The system of claim 33, wherein the means for encoding further comprises means for compressing the block of the current video frame.

37. The system of claim 33, further comprising:
means for transferring the new data in the second format from a buffer to a memory location;
means for encoding a corresponding block of a subsequent video frame using the new data in the second format in the memory location.

38. The system of claim 33, further comprising means for transferring a portion of the block of video data from the buffer to the memory location if the buffer is full prior to encoding the entire block of video data.
